(19) United States
(12) Patent Application Publication
(10) Pub. No.: US 2025/0381960 A1
(43) Pub. Date: Dec. 18, 2025

(54) CONTROL DEVICE FOR VEHICLE, STORAGE MEDIUM, AND CONTROL METHOD

(71) Applicants: TOYOTA JIDOSHA KABUSHIKI KAISHA, Toyota-shi (JP); ADVICS CO., LTD., Kariya-shi (JP)

(72) Inventors: Kazuki MIYAKE, Okazaki-shi (JP); Masumi DAKEMOTO, Nagoya-shi (JP); Taketsugu MIYATA, Toyota-shi (JP); Yusuke KAMIYA, Toyota-shi (JP); Sotaro MURAMATSU, Tokyo (JP)

(73) Assignees: TOYOTA JIDOSHA KABUSHIKI KAISHA, Toyota-shi (JP); ADVICS CO., LTD., Kariya-shi (JP)

(21) Appl. No.: 19/233,882

(22) Filed: Jun. 10, 2025

(30) Foreign Application Priority Data
Jun. 17, 2024 (JP) 2024-097512

(51) Int. Cl. B60W 30/18

(52) U.S. Cl. CPC B60W 30/18009; B60W 2510/182; B60W 2510/20; B60W 2520/105

(57) ABSTRACT

A control device for a vehicle, a storage medium, and a control method are provided. The control device includes processing circuitry configured to receive a motion request of a vehicle from each of driver-assistance systems. The vehicle includes the driver-assistance systems. The processing circuitry is configured to select one of the received motion requests as an arbitration result, and output, based on the arbitration result, an instruction signal that is used to control an actuator of the vehicle, and vary the instruction signal over a predetermined period of time when the instruction signal switches as the motion request switches.

### CROSS-REFERENCE TO RELATED APPLICATIONS

This application is based upon and claims the benefit of priority from Japanese Patent Application No. 2024-097512, filed on Jun. 17, 2024, the entire contents of which are incorporated herein by reference.

### BACKGROUND

### 1. Field

The present disclosure relates to a control device for a vehicle, a storage medium, and a control method.

### 2. Description of Related Art

Japanese Laid-Open Patent Publication No. 2020-32894 discloses a control device that serves as a motion manager. The motion manager receives motion requests from driver-assistance systems and arbitrates these motion requests. The motion manager outputs instruction signals to control the actuators of a vehicle based on the arbitration results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a control device for a vehicle. The control device includes processing circuitry configured to receive a motion request of a vehicle from each of driver-assistance systems. The vehicle includes the driver-assistance systems. The processing circuitry is configured to select one of the received motion requests as an arbitration result, output, based on the arbitration result, an instruction signal that is used to control an actuator of the vehicle, and vary the instruction signal over a predetermined period of time when the instruction signal switches as the motion request switches.

Another aspect of the present disclosure provides a storage medium. The storage medium is a non-transitory computer-readable storage medium that stores a program for causing a processing device to execute a control process. The control process includes receiving a motion request of the vehicle from each of driver-assistance systems. The vehicle includes the driver-assistance systems. The control process includes selecting one of the received motion requests as an arbitration result, outputting, based on the arbitration result, an instruction signal that is used to control an actuator of the vehicle, and varying the instruction signal over a predetermined period of time when the instruction signal switches as the motion request switches.

Yet another aspect of the present disclosure provides a control method executed by a control device that includes processing circuitry. The control method includes receiving, by the processing circuitry, a motion request of the vehicle from each of driver-assistance systems. The vehicle includes the driver-assistance systems. The control method includes selecting, by the processing circuitry, one of the received motion requests as an arbitration result, outputting, by the processing circuitry, based on the arbitration result, an instruction signal that is used to control an actuator of the vehicle, and varying, by the processing circuitry, the instruction signal over a predetermined period of time when the instruction signal switches as the motion request switches.

In the vehicle that includes the driver-assistance systems, abrupt changes in the output of the actuators are limited.

Gcnerally, when the motion request switches as the arbitration result changes, the motion request may be immediately switched. In this case, the instruction signal will change abruptly. As a result, the output of the actuators may be changed suddenly. The above-described configuration reduces such a risk.

Other features and aspects will be apparent from the following detailed description, the drawings, and the claims.

### BRIEF DESCRIPTION OF THE DRAWINGS

FIG. 1 is a schematic diagram showing the configuration of a vehicle according to an embodiment.

FIG. 2 is a functional block diagram that illustrates the basic configuration of the motion manager in the vehicle of the present embodiment shown in FIG. 1.

FIG. 3 is a functional block diagram that illustrates the arbitration unit of the present embodiment shown in FIG. 2.

FIG. 4 is a flowchart illustrating the procedure of processes that calculate the target acceleration in the present embodiment.

FIG. 5 is a timing diagram illustrating the operation of the present embodiment.

FIG. 6 is a timing diagram illustrating the operation of the present embodiment.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Schematic Configuration of Vehicle

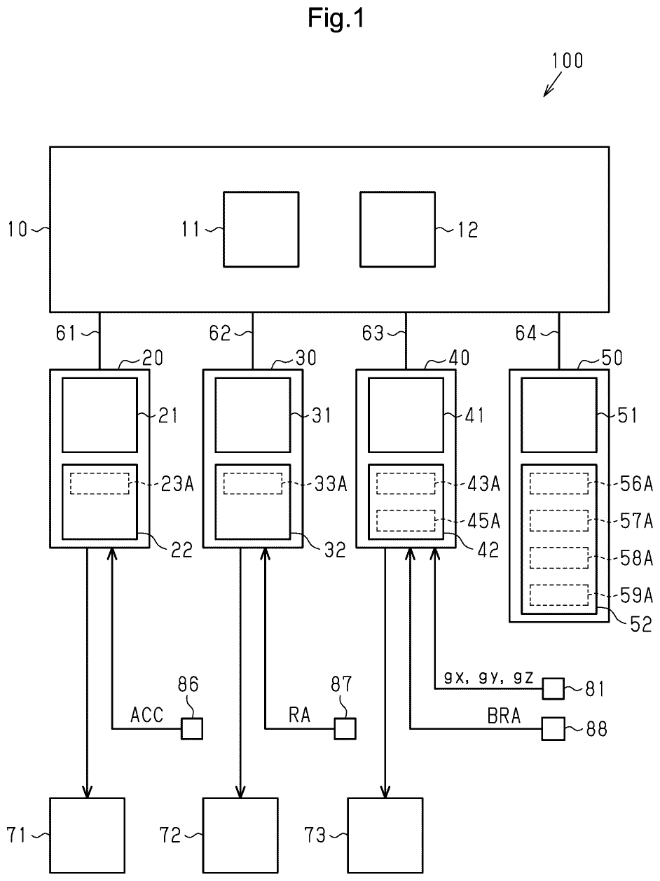

The present disclosure according to an embodiment will now be described with reference to FIGS. 1 to 6. The present embodiment is employed in a control device for a vehicle, a control method, a storage medium, a control program, a control program product, and a control process. First, the schematic configuration of a vehicle 100 will be described.

As shown in FIG. 1, the vehicle 100 includes a powertrain device 71, a steering device 72, and a brake device 73. In the present embodiment, each of the powertrain device 71, the steering device 72, and the brake device 73 is an actuator of the vehicle 100.

The powertrain device 71 includes, for example, an engine, a motor generator, and a transmission. The engine is configured to transmit driving force to the drive wheels of the vehicle 100 through the transmission. The motor generator is configured to transmit driving force to the drive wheels of the vehicle 100 through the transmission.

The steering device 72 is, for example, a rack-and-pinion electric steering device. The steering device 72 is configured to change the orientation of the steering wheels of the vehicle 100 by controlling the rack and pinion (not shown).

The brake device 73 is a mechanical brake device that mechanically brakes the wheels of the vehicle 100. In the present embodiment, the brake device 73 is, for example, a disc brake.

As shown in FIG. 1, the vehicle 100 includes a central electronic control unit (ECU) 10, a powertrain ECU 20, a steering ECU 30, a brake ECU 40, and an advanced driver-assistance ECU 50. The vehicle 100 includes a first external bus 61, a second external bus 62, a third external bus 63, and a fourth external bus 64.

The central ECU 10 centrally controls the entire vehicle 100. The central ECU 10 includes a central processing device 11 and a central storage device 12. The central processing device 11 is, for example, a central processing unit (CPU). The central storage device 12 includes a read-only memory (ROM), which only allows data to be read, a random-access memory (RAM), which is a volatile memory allowing data to be read and written, and a non-volatile storage, which allows data to be read and written. The central storage device 12 stores various programs and various types of data in advance. The central processing device 11 is an execution device, a processing device, and processing circuitry that execute various processes by executing programs stored in the central storage device 12.

The powertrain ECU 20 is configured to communicate with the central ECU 10 via the first external bus 61. The powertrain ECU 20 controls the powertrain device 71 by outputting control signals to the powertrain device 71. The powertrain ECU 20 includes a powertrain processing device 21 and a powertrain storage device 22. The powertrain processing device 21 is, for example, a CPU. The powertrain storage device 22 includes a ROM, a RAM, and a storage. The powertrain storage device 22 stores various programs and various types of data in advance. Specifically, the powertrain storage device 22 stores a powertrain app 23A in advance as one of the programs. The powertrain app 23A is application software designed to control the powertrain device 71. The powertrain processing device 21 is processing circuitry that acts as a powertrain control unit 23, which will be described later, by executing the powertrain app 23A stored in the powertrain storage device 22. In the present embodiment, the powertrain ECU 20 is a control device that controls the powertrain device 71.

The steering ECU 30 is configured to communicate with the central ECU 10 via the second external bus 62. The steering ECU 30 controls the steering device 72 by outputting control signals to the steering device 72. The steering ECU 30 includes a steering processing device 31 and a steering storage device 32. The steering processing device 31 is, for example, a CPU. The steering storage device 32 includes a ROM, a RAM, and a storage. The steering storage device 32 stores various programs and various types of data in advance. Specifically, the steering storage device 32 stores a steering app 33A as one of the programs. The steering app 33A is application software designed to control the steering device 72. The steering processing device 31 is processing circuitry that acts as a steering control unit 33, which will be described later, by executing the steering app 33A stored in the steering storage device 32. In the present embodiment, the steering ECU 30 is a control device that controls the steering device 72.

The brake ECU 40 is configured to communicate with the central ECU 10 via the third external bus 63. The brake ECU 40 controls the brake device 73 by outputting control signals to the brake device 73. The brake ECU 40 includes a brake processing device 41 and a brake storage device 42. The brake processing device 41 is, for example, a CPU. The brake storage device 42 includes a ROM, a RAM, and a storage. The brake storage device 42 stores various programs and various types of data in advance. Specifically, the brake storage device 42 that stores the brake app 43A as one of the programs in advance. The brake app 43A is application software designed to control the brake device 73. The brake storage device 42 stores a motion manager app 45A in advance as one of the programs. The motion manager app 45A is application software designed to arbitrate motion requests. The brake processing device 41 is processing circuitry that acts as a brake control unit 43, which will be described later, by executing the brake app 43A stored in the brake storage device 42. The brake processing device 41 serves as a motion manager 45, which will be described later, by executing the motion manager app 45A stored in the brake storage device 42. In the present embodiment, the brake ECU 40 serves as a control device and processing circuitry. The motion manager app 45A is a control program or a control program product. That is, the brake processing device 41 of the brake ECU 40 executes various processes in the control method by running the motion manager app 45A. The brake ECU 40 is a control device that controls the brake device 73.

The advanced driver-assistance ECU 50 is configured to communicate with the central ECU 10 via the fourth external bus 64. The advanced driver-assistance ECU 50 performs various types of driver assistance functions. The advanced driver-assistance ECU 50 is a computer including an advanced driving processing device 51 and an advanced driving storage device 52. The advanced driving processing device 51 is, for example, a CPU. The advanced driving storage device 52 includes a ROM, a RAM, and a storage. The advanced driving storage device 52 stores various programs and various types of data in advance. The programs include a first assistance app 56A, a second assistance app 57A, a third assistance app 58A, and a fourth assistance app 59A. The first assistance app 56A is, for example, application software for an autonomous emergency braking (AEB) system that automatically brakes to mitigate the impact of a collision with the vehicle 100. The second assistance app 57A is, for example, application software for lane keeping assist (LKA) that ensures the vehicle 100 stays in the current lane. The third assistance app 58A is, for example, application software used for adaptive cruise control that follows a preceding vehicle traveling ahead of the vehicle 100 while maintaining a constant distance from the preceding vehicle. The fourth assistance app 59A is, for example, application software for parking assistance that enables automatic parking for the vehicle 100. In the present embodiment, each of the first assistance app 56A, the second assistance app 57A, the third assistance app 58A, and the fourth assistance app 59A is application software that enables the driver assistance functions of the vehicle 100. The advanced driving processing device 51 is processing circuitry that acts as a first assistance unit 56 by executing the first assistance app 56A stored in the advanced driving storage device 52. The advanced driving processing device 51 acts as a second assistance unit 57 by executing the second assistance app 57A stored in the advanced driving storage device 52. The advanced driving processing device 51 acts as a third assistance unit 58 by executing the third assistance app 58A stored in the advanced driving storage device 52. The advanced driving processing device 51 acts as a fourth assistance unit 59 by executing the fourth assistance app 59A stored in the advanced driving storage device 52. In the present embodiment, the advanced driver-assistance ECU 50 is a control device included in a driver-assistance system. The control of driver assistance executed by the advanced driver-assistance ECU 50 may be referred to as advanced driver-assistance systems (ADAS) control.

The vehicle 100 includes an acceleration sensor 81, an accelerator operation amount sensor 86, a steering angle sensor 87, and a brake operation amount sensor 88.

The acceleration sensor 81 is a three-axis sensor. In other words, the acceleration sensor 81 is configured to detect a front-rear acceleration gx, a left-right acceleration gy, and an up-down acceleration gz.

The front-rear acceleration GX acts along the longitudinal axis of the vehicle 100. The acceleration acting in the driving direction of the vehicle 100 is represented by a positive value. The deceleration, which is the acceleration acting in the braking direction of the vehicle 100, is represented by a negative value. Thus, the value of the front-rear acceleration gx when the driving force of the vehicle 100 is relatively large is greater than that when the driving force of the vehicle 100 is relatively small. That is, when the value of the front-rear acceleration gx is positive and the driving force of the vehicle 100 is greater, the absolute value of the front-rear acceleration gx is larger. The value of the front-rear acceleration gx when the braking force of the vehicle 100 is relatively small is greater than that when the braking force of the vehicle 100 is relatively large. That is, when the value of the front-rear acceleration gx is negative and the braking force of the vehicle 100 is smaller, the absolute value of the front-rear acceleration gx is smaller.

The left-right acceleration gy is the acceleration acting along the lateral axis of the vehicle 100. The acceleration acting leftward on the vehicle 100 is represented by a positive value, and the acceleration acting rightward on the vehicle 100 is represented by a negative value.

The up-down acceleration gz is the acceleration acting along the vertical axis of the vehicle 100. The acceleration acting upward on the vehicle 100 is represented by a positive value, and the acceleration acting downward on the vehicle 100 is represented by a negative value. The terms “front,” “rear,” “left,” “right,” “up,” and “down” refer to directions as viewed from the driver's seat of the vehicle 100.

The accelerator operation amount sensor 86 detects an accelerator operation amount ACC. The accelerator operation amount ACC is the operation amount of the accelerator pedal operated by the driver of the vehicle 100.

The steering angle sensor 87 detects a steering angle RA. The steering angle RA is the angular position of the steering shaft operated by the driver. In the present embodiment, when the steering shaft is in the neutral position, that is, when the vehicle 100 is traveling straight, the steering angle RA is set to a reference position of 0. The steering angle RA when the vehicle 100 is turning left is represented by a positive value. The steering angle RA when the vehicle 100 is turning right is represented by a negative value.

The brake operation amount sensor 88 detects a brake operation amount BRA, which is the operation amount of the brake pedal operated by the driver.

The powertrain ECU 20 acquires a signal indicating the accelerator operation amount ACC from the accelerator operation amount sensor 86. The steering ECU 30 acquires a signal indicating the steering angle RA from the steering angle sensor 87. The brake ECU 40 acquires signals indicating the front-rear acceleration gx, the left-right acceleration gy, and the up-down acceleration gz from the acceleration sensor 81. The brake ECU 40 acquires a signal indicating the brake operation amount BRA from the brake operation amount sensor 88. The brake ECU 40 is configured to acquire various values, including the accelerator operation amount ACC and the steering angle RA, via the central ECU 10.

### Motion Manager

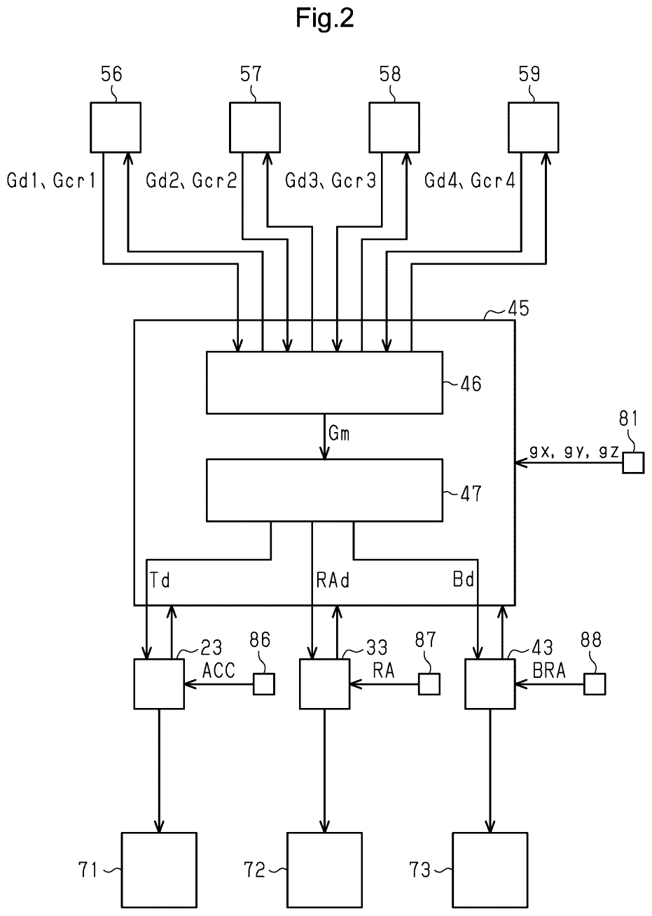

The motion manager 45 will now be described with reference to FIGS. 2 to 4.

As shown in FIG. 2, the motion manager 45 is configured to communicate with the first assistance unit 56, the second assistance unit 57, the third assistance unit 58, and the fourth assistance unit 59. The motion manager 45 is configured to communicate with the powertrain control unit 23, the steering control unit 33, and the brake control unit 43. The motion manager 45 is configured to acquire, for example, the front-rear acceleration gx. In the present embodiment, the front-rear acceleration gx is an example of the actual acceleration of the vehicle 100.

To execute various controls, the first assistance unit 56, the second assistance unit 57, the third assistance unit 58, and the fourth assistance unit 59 output motion requests to the motion manager 45. The first assistance unit 56, the second assistance unit 57, the third assistance unit 58, and the fourth assistance unit 59 each continue to output the motion request from when the controls become necessary to when the controls are no longer needed. The motion request includes, for example, a requested acceleration Gd to control the front-rear acceleration gx.

The motion manager 45 includes an arbitration unit 46 and an output unit 47.

The arbitration unit 46 receives the requested acceleration Gd and the like as motion requests from the first assistance unit 56, the second assistance unit 57, the third assistance unit 58, and the fourth assistance unit 59. Hereinafter, the requested acceleration Gd received by the arbitration unit 46 from the first assistance unit 56 is referred to as the first requested acceleration Gd1. The requested acceleration Gd received by the arbitration unit 46 from the second assistance unit 57 is referred to as the second requested acceleration Gd2. The requested acceleration Gd received by the arbitration unit 46 from the third assistance unit 58 is referred to as the third requested acceleration Gd3. The requested acceleration Gd received by the arbitration unit 46 from the fourth assistance unit 59 is referred to as the fourth requested acceleration Gd4. The arbitration unit 46 arbitrates the received requested accelerations Gd according to predefined rules. For example, in a case in which the arbitration unit 46 has received the requested acceleration Gd from each of the assistance units, the arbitration unit 46 selects the smallest acceleration from the requested accelerations Gd as the arbitration result.

The arbitration unit 46 receives an acceleration change rate Gcr from the first assistance unit 56, the second assistance unit 57, the third assistance unit 58, and the fourth assistance unit 59. The acceleration change rate Gcr is the amount of change per unit time of the acceleration of the vehicle 100 and is used to modify the vehicle acceleration toward the requested acceleration Gd. The first assistance unit 56, the second assistance unit 57, the third assistance unit 58, and the fourth assistance unit 59 each set an optimal acceleration change rate Gcr that has been pre-adapted to a corresponding motion request. Hereinafter, the acceleration change rate Gcr received by the arbitration unit 46 from the first assistance unit 56 is referred to as the first acceleration change rate Gcr1. The acceleration change rate Gcr received by the arbitration unit 46 from the second assistance unit 57 is referred to as the second acceleration change rate Gcr2. The acceleration change rate Gcr received by the arbitration unit 46 from the third assistance unit 58 is referred to as the third acceleration change rate Gcr3. The acceleration change rate Gcr received by the arbitration unit 46 from the fourth assistance unit 59 is referred to as the fourth acceleration change rate Gcr4.

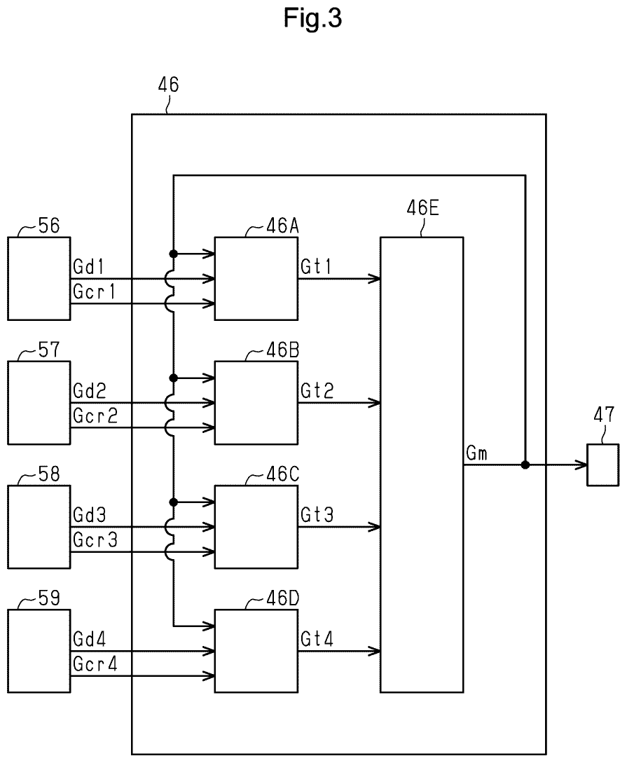

FIG. 3 is a functional block diagram of the arbitration unit 46.

The arbitration unit 46 includes a first target acceleration calculation unit 46A, a second target acceleration calculation unit 46B, a third target acceleration calculation unit 46C, a fourth target acceleration calculation unit 46D, and a selection unit 46E.

The first target acceleration calculation unit 46A acquires the first requested acceleration Gd1 and the first acceleration change rate Gcr1 from the first assistance unit 56. The first target acceleration calculation unit 46A acquires, from the selection unit 46E, an arbitrated acceleration Gm that was calculated in the previous calculation cycle. The first target acceleration calculation unit 46A calculates the first target acceleration Gt1 based on the first requested acceleration Gd1, the first acceleration change rate Gcr1, and the arbitrated acceleration Gm, which was calculated in the previous calculation cycle. If there is no motion request from the first assistance unit 56, in other words, if there is no execution request for the above-described AEB, the first target acceleration Gt1 is not calculated.

The second target acceleration calculation unit 46B acquires the second requested acceleration Gd2 and the second acceleration change rate Gcr2 from the second assistance unit 57. The second target acceleration calculation unit 46B acquires the arbitrated acceleration Gm, which was calculated in the previous calculation cycle, from the selection unit 46E. The second target acceleration calculation unit 46B calculates the second target acceleration Gt2 based on the second requested acceleration Gd2, the second acceleration change rate Gcr2, and the arbitrated acceleration Gm, which was calculated in the previous calculation cycle. If there is no motion request from the second assistance unit 57, in other words, if there is no execution request for the above-described LKA, the second target acceleration Gt2 is not calculated.

The third target acceleration calculation unit 46C acquires the third requested acceleration Gd3 and the third acceleration change rate Gcr3 from the third assistance unit 58. The third target acceleration calculation unit 46C acquires the arbitrated acceleration Gm, which was calculated in the previous calculation cycle, from the selection unit 46E. The third target acceleration calculation unit 46C calculates the third target acceleration Gt3 based on the third requested acceleration Gd3, the third acceleration change rate Gcr3, and the arbitrated acceleration Gm, which was calculated in the previous calculation cycle. If there is no motion request from the third assistance unit 58, in other words, if there is no execution request for the above-described ACC, the third target acceleration Gt3 is not calculated.

The fourth target acceleration calculation unit 46D acquires the fourth requested acceleration Gd4 and the fourth acceleration change rate Gcr4 from the fourth assistance unit 59. The fourth target acceleration calculation unit 46D acquires the arbitrated acceleration Gm, which was calculated in the previous calculation cycle, from the selection unit 46E. The fourth target acceleration calculation unit 46D calculates the fourth target acceleration Gt4 based on the fourth requested acceleration Gd4, the fourth acceleration change rate Gcr4, and the arbitrated acceleration Gm, which was calculated in the previous calculation cycle. If there is no motion request from the fourth assistance unit 59, in other words, if there is no execution request for the above-described parking assistance, the fourth target acceleration Gt4 is not calculated.

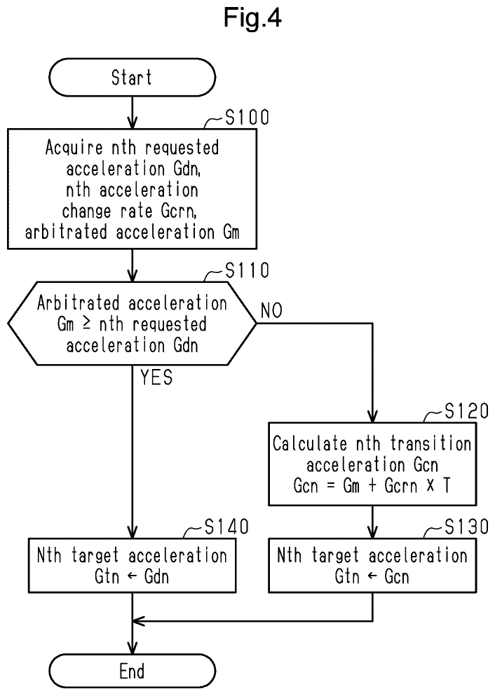

FIG. 4 illustrates the procedure for processes that calculate the first target acceleration Gt1, the second target acceleration Gt2, the third target acceleration Gt3, and the fourth target acceleration Gt4.

In FIG. 4, n indicates the type of target acceleration. When n=1, FIG. 4 illustrates the processes that calculate the first target acceleration Gt1. When n=2, FIG. 4 illustrates the processes that calculate the second target acceleration Gt2. When n=3, FIG. 4 illustrates the processes that calculate the third target acceleration Gt3. When n=4, FIG. 4 illustrates the processes that calculate the fourth target acceleration Gt4. The brake ECU 40 repeatedly executes these calculation processes at a predetermined execution cycle T. In the following description, the number of each step is represented by the letter S followed by a numeral.

Upon initiating the present process, the brake ECU 40 acquires a nth requested acceleration Gdn and a nth acceleration change rate Gcrn. The brake ECU 40 further acquires the arbitrated acceleration Gm, which was calculated in the previous calculation cycle (S100).

Next, the brake ECU 40 determines whether the arbitrated acceleration Gm calculated in the previous calculation cycle is greater than or equal to the nth requested acceleration Gdn (S110).

In the process of S110, when determining that the arbitrated acceleration Gm calculated in the previous calculation cycle is less than the nth requested acceleration Gdn (S110: NO), the brake ECU 40 calculates a nth transition acceleration Gcn (S120). The value of the nth transition acceleration Gcn gradually varies the current acceleration toward the nth requested acceleration Gdn. The value of the nth transition acceleration Gcn varies a motion request such that an instruction signal varies over a predetermined period of time when the instruction signal switches as the motion request switches.

The nth transition acceleration Gcn is calculated based on the following equation (1).

Gcn=Arbitrated acceleration Gm calculated in the previous calculation cycle+nth acceleration change rate Gcrn×execution cycle T of the present process (1)

Upon executing the process of S120, the brake ECU 40 then substitutes the calculated nth transition acceleration Gcn into a nth target acceleration Gtn (S130).

In the process of S110, when determining that the arbitrated acceleration Gm calculated in the previous calculation cycle is greater than or equal to the nth requested acceleration Gdn (S110: YES), the brake ECU 40 substitutes the nth requested acceleration Gdn into the nth target acceleration Gtn (S140).

After executing the process of step S130 or the process of step S140, the brake ECU 40 ends the current execution cycle of the present process.

The selection unit 46E acquires the first target acceleration Gt1 from the first target acceleration calculation unit 46A. The selection unit 46E acquires the second target acceleration Gt2 from the second target acceleration calculation unit 46B. The selection unit 46E acquires the third target acceleration Gt3 from the third target acceleration calculation unit 46C. The selection unit 46E acquires the fourth target acceleration Gt4 from the fourth target acceleration calculation unit 46D. The selection unit 46E arbitrates the acquired target accelerations according to the predefined rule. For example, the rule defined for the present embodiment is that the smallest value is selected from the acquired target accelerations. Accordingly, the selection unit 46E executes an arbitration process that selects the smallest one of the first target acceleration Gt1, the second target acceleration Gt2, the third target acceleration Gt3, and the fourth target acceleration Gt4 as the arbitration result. The selection unit 46E substitutes the selected target acceleration into the arbitrated acceleration Gm. The selection unit 46E outputs the arbitrated acceleration Gm to the output unit 47.

As shown in FIG. 2, the output unit 47 outputs instruction signals for motion requests to control various actuators based on the arbitrated acceleration Gm, which is the arbitration result. Examples of the actuators include the powertrain device 71, the steering device 72, and the brake device 73. The output of the powertrain device 71 is a driving force. The output of the steering device 72 is a steering angle. The output of the brake device 73 is a braking force.

For example, when the value of the arbitrated acceleration Gm, which is the arbitration result, indicates the driving direction, the output unit 47 calculates a requested driving force Td, which is the instruction signal to obtain the arbitrated acceleration Gm. The requested driving force Td is the instruction value of the driving force. The output unit 47 outputs the requested driving force Td to the powertrain control unit 23. The powertrain control unit 23 controls the powertrain device 71 to obtain the requested driving force Td. For example, when the value of the arbitrated acceleration Gm indicates the braking direction, the output unit 47 calculates a requested braking force Bd, which is the instruction signal to obtain the arbitrated acceleration Gm. The requested braking force Bd is the instruction value of the braking force. The output unit 47 outputs the requested braking force Bd to the brake control unit 43. The brake control unit 43 controls the brake device 73 to obtain the requested braking force Bd. Hereinafter, a case in which the motion request is a target curvature CUt in a target path of the vehicle 100 will be described. When arbitration is performed for the target curvature CUt, the output unit 47 calculates a requested steering angle RAd, which is the instruction signal to obtain the arbitrated target curvature CUt. The requested steering angle RAd is the instruction value of the steering angle. The output unit 47 outputs the requested steering angle RAd to the steering control unit 33. The steering control unit 33 controls the steering device 72 to obtain the requested steering angle RAd. In this manner, the instruction signal output by the output unit 47 is received by a control unit corresponding to an actuator intended to be controlled. The control unit controls the actuator.

Each of the powertrain control unit 23, the steering control unit 33, and the brake control unit 43 is configured to receive an operation request from the driver of the vehicle 100. The powertrain control unit 23 is configured to receive the accelerator operation amount ACC as the operation request from the driver. The accelerator operation amount sensor 86 detects the accelerator operation amount ACC. The steering control unit 33 is configured to receive the steering angle RA, which is detected by the steering angle sensor 87, as the operation request from the driver. The brake control unit 43 is configured to receive the brake operation amount BRA, which is detected by the brake operation amount sensor 88, as the operation request from the driver.

When receiving the operation request from the driver, each of the powertrain control unit 23, the steering control unit 33, and the brake control unit 43 controls a corresponding actuator according to the magnitude of the operation request from the driver.

### Operation of the Present Embodiment

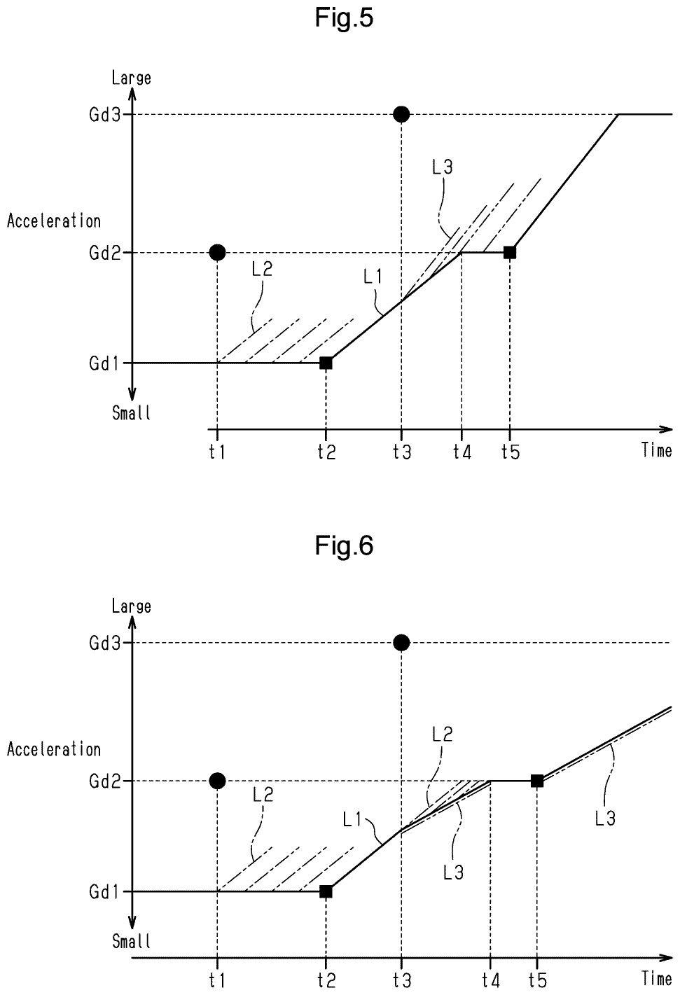

FIG. 5 illustrates an example of the changes in the arbitrated acceleration Gm. The solid line L1, shown in FIG. 5, illustrates the actual changes in the arbitrated acceleration Gm. The single-dashed line L2, shown in FIG. 5, illustrates the changes in the arbitrated acceleration Gm when a second transition acceleration Gc2 is selected as the arbitrated acceleration Gm. The double-dashed line L3, shown in FIG. 5, illustrates the changes in the arbitrated acceleration Gm when a third transition acceleration Gc3 is selected as the arbitrated acceleration Gm. In the example shown in FIG. 5, the magnitude of the acceleration is: the first requested acceleration Gd1>the second requested acceleration Gd2>the third requested acceleration Gd3. In other words, the third acceleration change rate Gcr3 has a greater value than the second acceleration change rate Gcr2. The actuator controls the front-rear acceleration gx of the vehicle 100 to match the arbitrated acceleration Gm.

Before time t1, driver assistance is performed by the first assistance unit 56. In other words, only the first requested acceleration Gd1 from the first assistance unit 56 occurs. The front-rear acceleration gx is controlled to match the first requested acceleration Gd1.

At time t1, driver assistance by the second assistance unit 57 is initiated, so that the second requested acceleration Gd2 is generated from the second assistance unit 57. Once the second transition acceleration Gc2 is calculated, the second transition acceleration Gc2 is substituted into the second target acceleration Gt2. The value of the second transition acceleration Gc2 is greater than that of the first requested acceleration Gd1. The selection unit 46E selects the smallest one of input accelerations. Therefore, the selection unit 46E maintains the arbitrated acceleration Gm at the first requested acceleration Gd1 by substituting the first requested acceleration Gd1 into the arbitrated acceleration Gm.

At time t2, the driver assistance by the first assistance unit 56 ends. That is, the first requested acceleration Gd1 is eliminated. Then, the selection unit 46E substitutes the second transition acceleration Gc2 into the arbitrated acceleration Gm. Before time t2, the value of the arbitrated acceleration Gm matched the first requested acceleration Gd1. The arbitrated acceleration Gm gradually changes following the second acceleration change rate Gcr2 toward the second requested acceleration Gd2 from time t2 onward.

At time t3, driver assistance by the third assistance unit 58 is initiated. Therefore, the third assistance unit 58 generates the third requested acceleration Gd3. When the third transition acceleration Gc3 is calculated, the third transition acceleration Gc3 is substituted into the third target acceleration Gt3. The value of the third acceleration change rate Gcr3 is greater than that of the second acceleration change rate Gcr2. Thus, the value of the third target acceleration Gt3, into which the third transition acceleration Gc3 has been substituted, is greater than the second target acceleration Gt2, into which the second transition acceleration Gc2 has been substituted. The selection unit 46E selects the smallest one of input accelerations. Thus, the selection unit 46E selects the second target acceleration Gt2 and substitutes the second target acceleration Gt2 into the arbitrated acceleration Gm. The actual arbitrated acceleration Gm changes in accordance with the second acceleration change rate Gcr2.

At time t4, when the arbitrated acceleration Gm reaches the second requested acceleration Gd2, the second requested acceleration Gd2 is substituted into the second target acceleration Gt2. The value of the second requested acceleration Gd2 is smaller than that of the third transition acceleration Gc3. The selection unit 46E selects the smallest one of input accelerations. Accordingly, the selection unit 46E substitutes the second requested acceleration Gd2 into the arbitrated acceleration Gm. Therefore, after time t4, the arbitrated acceleration Gm is maintained at the second requested acceleration Gd2.

At time t5, the driver assistance by the second assistance unit 57 ends. Therefore, the second requested acceleration Gd2 is eliminated. Then, the selection unit 46E substitutes the third transition acceleration Gc3 into the arbitrated acceleration Gm. Before time t5, the arbitrated acceleration Gm matched the value of the second requested acceleration Gd2. After time t5, the arbitrated acceleration Gm gradually changes toward the third requested acceleration Gd3 in accordance with the third acceleration change rate Gcr3.

FIG. 6 illustrates another example of the changes in the arbitrated acceleration Gm. The solid line L1, the single-dashed line L2, and the double-dashed line L3 shown in FIG. 6 are identical to those in FIG. 5. Between times t3 and t4 in FIG. 6, the double-dashed line L3 is illustrated slightly offset from the solid line L1 for clarity of illustration. In practice, the solid line L1 coincides with the double-dashed line L3. Likewise, after time t5 in FIG. 6, the double-dashed line L3 is illustrated slightly offset from the solid line L1 for clarity of illustration. In practice, the solid line L1 coincides with the double-dashed line L3. The example shown in FIG. 6 differs from the example shown in FIG. 5 in that the value of the third acceleration change rate Gcr3 is smaller than that of the second acceleration change rate Gcr2 (Gcr3<Gcr2).

The operation performed before time t3 in FIG. 6 are identical to that before time t3 in FIG. 5. The operation in FIG. 6 after time t3 will be described below.

At time t3, driver assistance by the third assistance unit 58 is initiated. Therefore, the third assistance unit 58 generates the third requested acceleration Gd3. Then, the third transition acceleration Gc3 is calculated. The third transition acceleration Gc3 is substituted into the third target acceleration Gt3. The value of the third acceleration change rate Gcr3 is smaller than the second acceleration change rate Gcr2 (Gcr3<Gcr2). Therefore, the value of the third target acceleration Gt3, into which the third transition acceleration Gc3 has been substituted, is smaller than the second target acceleration Gt2, into which the second transition acceleration Gc2 has been substituted. Accordingly, the selection unit 46E selects the third target acceleration Gt3 and substitutes the third target acceleration Gt3 into the arbitrated acceleration Gm. Thus, the value of the arbitrated acceleration Gm changes in accordance with the third acceleration change rate Gcr3. In this manner, when multiple requested accelerations, each having a different requested acceleration, the transition acceleration with the smallest value is substituted into the arbitrated acceleration Gm, from the transition accelerations calculated based on the acceleration charge rates respectively corresponding to the requested accelerations. For example, compared to a configuration in which the transition acceleration with the largest value is substituted into the arbitrated acceleration Gm, the present embodiment limits abrupt changes in the arbitrated acceleration Gm when the arbitrated acceleration Gm varies.

### Advantages of the Present Embodiment

(1) The vehicle 100 includes multiple driver-assistance systems. The motion manager 45 receives a requested acceleration from each of the driver-assistance systems of the vehicle 100. The requested acceleration is a motion request of the vehicle 100. Each target acceleration is based on the requested acceleration. The motion manager 45 selects, as the arbitration result, one of the target accelerations based on the received requested acceleration. The arbitrated acceleration Gm is the arbitration result. The motion manager 45 outputs the instruction value for the driving force or braking force based on the arbitrated acceleration Gm. The instruction value for the driving force or braking force is represented by an instruction signal used to control the actuators of the vehicle 100. When the instruction signal switches as the requested acceleration varies, the motion manager 45 calculates the transition acceleration as follows. The motion manager 45 calculates the transition acceleration such that the instruction signal varies over the predetermined period of time. As a result, the motion request is varied.

Therefore, when the requested acceleration switches, the arbitrated acceleration Gm gradually varies according to the transition acceleration. Since the instruction signal varies according to the arbitrated acceleration Gm, the instruction signal also gradually varies. Thus, the output changes of the above-described actuators in the vehicle 100 become gradual. Consequently, abrupt changes in the output of the actuators are limited in the vehicle 100, which includes the driver-assistance systems.

(2) The motion manager 45 acquires the acceleration change rate Gcr. The acceleration change rate Gcr is the rate of change in a motion request. The transition acceleration is calculated based on the acceleration change rate Gcr. The motion manager 45 varies the motion request by setting the transition acceleration to the target acceleration when the motion request is switched. The target acceleration is a calculated value for the motion request. The requested driving force Td and the requested braking force Bd are gradually varied through the changes in the target acceleration. The requested driving force Td and the requested braking force Bd are represented by instruction signals. This allows the output of the actuators of the vehicle 100 to be gradually varied.

(3) The requested acceleration varies as the driver assistance by the assistance unit switches. In this situation, for instance, the following first comparative example may be used to limit abrupt changes in the output of the actuators of the vehicle 100.

In the first comparative example, one of the requested accelerations has been selected as the result of arbitration. Each non-selected requested acceleration has a corresponding value of the requested acceleration that the non-selected requested acceleration is originally expected to reach. In the first comparative example, the expected value of the requested acceleration, which is originally expected to be reached, is not set to a provisional target acceleration for the non-selected requested acceleration. In the first comparative example, the provisional target acceleration for the non-selected requested acceleration is set to a value slightly greater than the selected acceleration. After the provisional target acceleration is set, the first comparative example enters a standby state. The provisional target acceleration is set in the first comparative example to enable the driver-assistance system to identify which assistance unit has requested the current acceleration. When the selected requested acceleration eventually disappears, one of the requested accelerations that has been in the standby state is selected as the new arbitration result. In this case, the first comparative example gradually varies the acceleration from the provisional target acceleration to a new requested acceleration that has been selected. The first comparative example limits abrupt changes in the output of the actuators of the vehicle 100 when the requested acceleration switches. However, the first comparative example may produce the following inconvenience. Each assistance unit needs to independently perform a process that determines a new requested acceleration while monitoring whether a new requested acceleration in the standby state has been selected. This results in the software becoming more complex. Further, in the first comparative example, the calculation cycle from which each assistance unit can recognize whether its requested acceleration has been selected is provided next to the calculation cycle in which the requested acceleration of each assistance unit has been determined. Thus, in the first comparative example, the process that varies the acceleration toward the value of the requested acceleration that is originally expected to be reached is delayed by one calculation cycle.

In the present embodiment, each assistance unit outputs the requested acceleration Gd and the acceleration change rate Gcr to the arbitration unit 46. This output process alone limits abrupt changes in the output of the actuators. Thus, the present embodiment eliminates the need for all assistance units to execute a process that determines a new requested acceleration while monitoring whether the requested acceleration in the standby state has been selected. As a result, the inconvenience that occurs in the first comparative example is limited.

### Modifications

The present embodiment may be modified as described below. The present embodiment and the following modifications can be combined as long as the combined modifications remain technically consistent with each other.

The motion manager 45 may calculate the acceleration change rate Gcr.

The arbitration unit 46 may be arranged outside the motion manager 45.

The predefined rule for the selection unit 46E to perform arbitration may be changed. For example, a rule may be set to select the largest value of the acquired target accelerations. Alternatively, a rule may be set to select the median of the acquired target accelerations. The instruction signal may be at least one of the requested driving force Td or the requested braking force Bd. In this specification, the phrase “at least one of” means “one or more” of a desired choice. For example, the phrase “at least one of” as used in this description means “only one choice” or “both of two choices” if the number of choices is two.

In the above-described embodiment, the motion request is the acceleration of the vehicle 100, and the instruction signal is the requested driving force Td or the requested braking force Bd. Instead, the motion request may be the target curvature in the target path of the vehicle 100. The instruction signal may be the requested steering angle RAd. That is, the above-described control on the driving force or braking force during switching of the motion request may be performed on the steering angle of the vehicle 100.

The ECU that enables the functions of the motion manager 45 is not limited to the brake ECU 40. For example, instead of the brake ECU 40, the central processing device 11 of the central ECU 10 may enable the functions of the motion manager 45. That is, the central processing device 11 may enable the functions of the motion manager 45 by executing the motion manager app 45A, which is stored in the central storage device 12. The central ECU 10, the powertrain ECU 20, the steering ECU 30, the brake ECU 40, and the advanced driver-assistance ECU 50 may each be employed as the control device that enables the functions of the motion manager 45.

The motion manager, which serves as the control device or processing device, only needs to include a CPU and a ROM and execute software processing. The motion manager is not limited to this configuration. That is, the motion manager may be modified as long as it has any one of the following configurations (a) to (c).

(a) The motion manager includes one or more processors that execute various processes in accordance with a computer program. The processor includes a CPU and a memory, such as a RAM and a ROM. The memory stores program codes or commands (e.g., information providing process) that are configured to have the CPU execute a process. The memory, or a non-transitory computer-readable storage medium, includes any type of media that are accessible by general-purpose computers and dedicated computers.

(b) The motion manager includes one or more dedicated hardware circuits that execute various processes. Examples of the dedicated hardware circuits include an application specific integrated circuit (ASIC) and a field programmable gate array (FPGA).

(c) The motion manager includes a processor that executes part of various processes in accordance with a computer program and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A control device for a vehicle, the control device comprising processing circuitry configured to:
receive a motion request of the vehicle from each of driver-assistance systems, wherein the vehicle includes the driver-assistance systems;
select one of the received motion requests as an arbitration result;
output, based on the arbitration result, an instruction signal that is used to control an actuator of the vehicle; and
vary the instruction signal over a predetermined period of time when the instruction signal switches as the motion request switches.

2. The control device for the vehicle according to claim 1, wherein
the processing circuitry is further configured to:
acquire a change rate of the motion request; and
vary the instruction signal by varying the motion request based on the change rate when the motion request is switched.

3. The control device for the vehicle according to claim 1, wherein
the motion request is an acceleration of the vehicle, and
the instruction signal includes an instruction value of at least one of a driving force of the vehicle and a braking force of the vehicle.

4. The control device for the vehicle according to claim 1, wherein
the motion request is a target curvature in a target path of the vehicle, and
the instruction signal includes an instruction value for a steering angle of the vehicle.

5. A non-transitory computer-readable storage medium that stores a program for causing a processing device to execute a control process, the control process comprising:
receiving a motion request of the vehicle from each of driver-assistance systems, wherein the vehicle includes the driver-assistance systems;
selecting one of the received motion requests as an arbitration result;
outputting, based on the arbitration result, an instruction signal that is used to control an actuator of the vehicle; and
varying the instruction signal over a predetermined period of time when the instruction signal switches as the motion request switches.

6. A control method executed by a control device that includes processing circuitry, the control method comprising:
receiving, by the processing circuitry, a motion request of the vehicle from each of driver-assistance systems, wherein the vehicle includes the driver-assistance systems;
selecting, by the processing circuitry, one of the received motion requests as an arbitration result;
outputting, by the processing circuitry, based on the arbitration result, an instruction signal that is used to control an actuator of the vehicle; and
varying, by the processing circuitry, the instruction signal over a predetermined period of time when the instruction signal switches as the motion request switches.
